(19) United States
(12) Patent Application Publication
(10) Pub. No.: US 2026/0004672 A1
(43) Pub. Date: Jan. 1, 2026

(54) SYSTEMS AND METHODS FOR ADAPTIVE REMOTE LEARNING

(71) Applicant: IU Group N.V., Bruxelles (BE)

(72) Inventors: Mark ZAKHVATKIN, Munich (DE); Quintus STIERSTORFER, Munich (DE)

(21) Appl. No.: 18/754,737

(22) Filed: Jun. 26, 2024

(51) Int. Cl. G09B 7/02; G10L 15/22

(52) U.S. Cl. CPC G09B 7/02; G10L 15/22

(57) ABSTRACT

The present application provides a system for interactively training students comprising a course database, a question database, a dialogue module, an AI Bot module, and a personalization database comprising personal attributes of the student, Additionally, there is provided a system for training students comprising a course database, an AI Bot, a knowledge state module, a problem selection module, a quantitative feedback module, and a qualitative feedback module. Additionally, there is provided a system for answering questions of students comprising a course database, an AI Bot module, a paraphrase detector module, and a response generation module. There are also provided related methods and program products employed by the systems disclosed in the present application.

### FIELD

The present invention generally relates to improvements in computer technology related to systems and methods for adaptive remote learning.

### BACKGROUND

Traditionally, studies at a university or school may consist of different courses having a specific course material which is to be learned by the students. Conventionally, courses are held by a physical human being serving as teacher. Even when classes are taught over the internet, such as with “massive open online courses” (MOOCs), such classes are still taught by a human instructor, often with little face-to-face contact between students and the human teacher. As a result, online teaching and training have become depersonalized, with students losing the ability to interact one-on-one with their teachers.

At the same time, current computer systems that exist for teaching and training have proven to have severe flaws. Systems implementing massive open online courses, for example, are usually configured to present information without adapting to the learning style and proclivities of individual student's taking the course.

What is needed is a way to improve computer systems so as to better enable distance learning.

### SUMMARY

In view of the above, it is an object of the present invention to provide a technological solution to address the long felt need and technological challenges faced in computer-based education.

As another advantage, the present invention provides an improved learning efficiency, reduces the number of people as teachers which are needed, and enhances the learning quality.

The present invention provides novel systems, methods, and computer program products of interactively training students, training students, and answering questions of students in order to these and other problems in the field.

In exemplary embodiments, a system for interactively training students includes a course database comprising data of a course material to be studied by the student for the specific course, question database comprising data of exam relevant questions related to the course material to be studied by the student, a predetermined percentage of which is required to be answered by the student to pass an exam related to the course, a dialogue module which is adapted to carry out an interactive dialogue with the student about the course material to be studied by the student and regarding the exam relevant questions, an Al Bot module which is configured to use the answer or comment given by the student in the dialogue to set up a new question or answer in the dialogue to be answered or commented by the student based on the data of a course material to be studied by the student and the data of exam relevant questions, and a personalization database comprising personal attributes of the student, wherein the system is configured that the attributes of the student are regarded by the Al bot such that the interactive dialogue deals also with topics which are relevant to the attributes and covers the course material to be studied by the student and takes the exam relevant questions into account.

In embodiments, the attributes of the student are one or more of the group comprising the following: motivation for passing the course, professional background, personal interests, admission documents; wherein in particular the Al Bot module is configured to adapt the complexity and/or content of the dialogue based on one or more or all of those attributes.

In embodiments, the course material consist of one coursebook having a specific topic or comprises multiple coursebooks having different topics which are related to the specific course of study.

In embodiments, the system includes a self-improvement module, in which the dialogue data of passed dialogues is saved and the Al Bot module is configured to take the dialogue data into account to set up a new question or answer in the dialogue.

In embodiments, the system includes a derail-detection module, in which it is determined that the student ask a question or gives a comment in the dialogue which is not related to the specific course, and if it is the case the dialogue is steered back to the specific course.

In embodiments, the system includes a grading module, which is configured to give a feedback concerning the knowledge status to pass the exam based on the dialogue history.

In exemplary embodiments, a method of interactively training students comprising the steps of carrying out an interactive dialogue with the student about a course material to be studied by the student for a specific course and taking into account exam relevant questions, related to the course material to be studied by the student, a predetermined percentage of which is required to be answered by the student to pass an exam related to the course. In embodiments, the answer or comment given by the student in the dialogue is used to set up a new question or answer in the dialogue to be answered or commented by the student based on the data of a course material to be studied by the student and the data of exam relevant questions. In embodiments, in order to set up a new question or answer in the dialogue an Al Bot module is used which takes the data of a course material to be studied by the student and the data of exam relevant questions into account. In embodiments, attributes of the student are regarded by the Al bot such that the interactive dialogue deals also with topics which are relevant to the attributes and covers the course material to be studied by the student and takes the exam relevant questions into account.

In embodiments, the method of interactively training students is performed based on computer executable instructions stored on a computer readable medium.

In exemplary embodiments, a system includes a course database comprising data of a course material to be studied by the student for the specific course, an AI Bot module which is configured to use the course material to be studied by the student to set up multiple problems to be solved in an exam, a knowledge state module which is adapted to determine the actual knowledge state the student, a problem selection module which is adapted to select a problem generated by the AI bot dependent on the actual knowledge state the student, a quantitative feedback module adapted to give a quantitative feedback to the student in relation to his input solution of the problem a qualitative feedback module adapted to give a qualitative feedback to the student in relation to his input solution of the problem. In embodiments, the system is configured that after the student has input the solution of the problem to the system the quantitative feedback and the qualitative feedback is given to the student. In embodiments, the system is further configured that before the problem which is set up by the Al Bot module is selected by the problem selection module, the problems are selected such that problems which are below a preset quality are removed from the possible problems to be selected.

In embodiments, the system is configured that the problems are selected by a human person having knowledge in the file of the specific course.

In embodiments, the quantitative feedback is a score given to the solution of the student and the AI Bot module is configured to take selected problem, the solution input by the student, a reference answer and the maximum score for solving said problem into account.

In embodiments, the qualitative feedback is an description explaining the student what would have be needed to obtain a higher score or the maximum score for solving said problem, the AI Bot module is configured to take selected problem, the solution input by the student, a reference answer into account.

In embodiments, the system further includes a knowledge state monitoring and matching module, which is adapted to continuously monitor the knowledge state and compares it with a predetermined knowledge state goal for passing an final exam, and if the monitored knowledge state matches the predetermined knowledge state, outputs an instruction that the student has passed the exam.

In embodiments, the knowledge state monitoring and matching module is hidden for the student such that the student is not aware that he is tested for passing the final exam continuously during the interaction with the system.

In embodiments, the knowledge state module is adapted to predict based on the history of the solutions p input from the student for each problem of the problems to be selected an expected score of the input solution at the present date, and optionally predict for each problem of the problems to be selected an expected score of the input solution at a future date by taking into the history of the predicted expected score of the input solution at a respective present date, and wherein said predicted score at the present date or the predicted score at the future date is regarded by the problem selection module to select an appropriate problem.

In exemplary embodiments, a method for training students includes the steps of using data of a course material to be studied by the student to set up with an AI bot multiple problems to be solved in an exam, determining the actual knowledge state the student, selecting a problem generated by an AI bot dependent on the actual knowledge state the student. In embodiments, after the student has input a solution of the problem the method further comprises to give a qualitative feedback and a quantitative feedback to the student. In embodiments, before the problem which is set up by the AI Bot module is selected, the problems are selected by a human person having knowledge in the file of the specific course such that problems which are below a preset quality are removed from the possible problems to be selected.

In embodiments, the method of training students is performed based on computer executable instructions stored on a computer readable medium.

In exemplary embodiments, a system for answering questions of students includes: a course database comprising data of a course material to be studied by the student for the specific course, an AI Bot module which is configured to use the course material to be studied by the student to set up artificial questions which may be potentially asked by the students taking into account the content of the course material and creating a data set where a respective artificial question is assigned to an expected response set up from the content of the course material, a paraphrase detector module which is adapted to analyze a question input from the student whether it has a predetermined amount of similarity to at least one of the artificial question and/or a previously asked question, and a response generation module which generates, if there is predetermined amount of similarity in the input question, a response to the question. In embodiments, the answers to the questions in the data set are reviewed by a human person having knowledge in the field of the specific course and approved or rewritten, so that the dataset comprises pairs of artificial questions and related approved or rewritten answers. In embodiments, approved or rewritten answer of the pairs of artificial questions and related approved or rewritten answers are used, which corresponding artificial question has the highest or at least a predetermined similarity. In embodiments, the system in configured to provide the answer to the student.

In embodiments, the system in configured to mark the provided answer as approved from the human person having knowledge in the field of the specific course, in particular by a visual tag.

In embodiments, the system further includes a content filter module with which it is determined that the student ask a question which is not related to the specific course, and if it is the case the question is not answered and/or the student is informed that the question is blocked.

In embodiments, if there is not a predetermined amount of similarity in the input question, the AI Bot module is configured to take the course material into account and formulate an answer and in particular does not use the pairs of artificial questions and related approved or rewritten answers. In embodiments, the system is configured to mark the provided answer as not approved from the human person having knowledge in the field of the specific course and/or as had been generated by AI.

In embodiments, a method for answering questions of students includes the steps of setting up with an AI Bot module artificial questions which may be potentially asked by the students taking into account the content of course material to be studied by the student for the specific course and creating a data set where a respective artificial question is assigned to an expected response set up by the AI Bot module from the content of the course material, wherein the answers to the questions in the data set are reviewed by a human person having knowledge in the field of the specific course and approved or rewritten, so that the dataset comprises pairs of artificial questions and related approved or rewritten answers, analyzing a question input from the student whether it has a predetermined amount of similarity to at least one of artificial question, generating, if there is predetermined amount of similarity in the input question, a response to the question, wherein as response there is used this approved or rewritten answer of the pairs of artificial questions and related approved or rewritten answers, which corresponding artificial question has the highest or at least a predetermined similarity, and providing the answer to the student.

In embodiments, a system for answering questions of students includes: a course database including data of a course material to be studied by the student for the specific course; an AI Bot module which is configured to: obtain the data; use the data to generate artificial questions which may be potentially based on content of the course material; use the data to generate a respective expected responses to each artificial question based upon the content of the course material; and create a data set where each artificial question is assigned to a respective expected response; wherein the answers to the questions in the data set are reviewed by a human person having knowledge in the field of the specific course and approved or rewritten, so that the dataset includes pairs of artificial questions and related approved or rewritten answers; a paraphrase detector module which is adapted to analyze a question input from the student whether it has a similarity equal to or above a predetermined amount of similarity to at least one of the artificial questions; and a response generation module which generates, if the similarity is equal to or above the predetermined amount of similarity to at least one of the artificial questions, a response to the question, wherein the is based on an approved or rewritten answer of the pairs of artificial questions and related approved or rewritten answers, which corresponding artificial question has the highest or at least a predetermined similarity, wherein the system in configured to provide the answer to the student.

In embodiments, the system in configured to mark the provided answer as approved from the human person having knowledge in the field of the specific course by a visual tag.

In embodiments, the method of answering questions of students is performed based on computer executable instructions stored on a computer readable medium.

In exemplary embodiments a system for interactively training a student includes a course database including first data of a course material to be studied by the student for a specific course; a question database including second data of exam relevant questions related to the course material to be studied by the student, a predetermined percentage of which is required to be answered by the student to pass an exam related to the course; a dialogue module which is configured to carry out an interactive dialogue with the student about the course material to be studied by the student and regarding the exam relevant questions, wherein the interactive dialogue includes a first answer given in response to a first question; an AI Bot module which is configured to: obtain first data from the course database; obtain second data from the question database; and use the first answer given by the student in the dialogue to generate a new question or answer in the dialogue to be answered or commented by the student based on at least the first data and the second data; and a personalization database including personal attributes of the student, wherein the AI Bot module generates the interactive dialogue based on third data obtained from the personalization database, such that the interactive dialogue deals with topics which are relevant to the attributes and covers the course material to be studied by the student and takes the exam relevant questions into account.

In embodiments, the attributes of the student include motivation for passing the course, professional background, personal interests, and/or admission documents; and wherein in particular the AI Bot module is configured to adapt the complexity and/or content of the dialogue based on one or more or all of those attributes.

In embodiments, the course material includes at least one coursebook having a specific topic or multiple coursebooks having different topics which are related to the specific course of study.

In embodiments, the system further includes self-improvement module, in which the dialogue data of past dialogues is saved in a self-improvement database and the AI Bot module is configured to take the dialogue data into account to set up a new question or answer in the dialogue.

In embodiments, the system further includes a derail-detection module, in which it is determined that the student ask a question or gives a comment in the dialogue which is not related to the specific course, and if it is the case the dialogue is steered back to the specific course.

In embodiments, the system further includes a grading module, which is configured to give a feedback concerning the knowledge status to pass the exam based on the dialogue history.

In embodiments, a system for training a student includes a course database including data of a course material to be studied by the student for a specific course; an AI Bot module which is configured to use the data to set up multiple problems to be solved in an exam; a knowledge state module which is configured to determine the actual knowledge state the student; a problem selection module which is configured to select a problem generated by the AI bot dependent on the actual knowledge state the student, wherein the selected problems are above a preset quality level; a quantitative feedback module configured to give a quantitative feedback to the student in relation to his input solution of the problem; a qualitative feedback module adapted to give a qualitative feedback to the student in relation to his input solution of the problem; wherein the system is configured to obtain a solution input from the student and provide quantitative feedback and qualitative feedback in response.,

In embodiments, the system is configured so that the problems are selected by a human person having knowledge in the file of the specific course.

In embodiments, the quantitative feedback is a score given to the solution of the student and the AI Bot module is configured to take the selected problem, the solution input by the student, a reference answer and the maximum score for solving said problem into account.

In embodiments, the qualitative feedback is a description explaining to the student what would have been needed to obtain a higher score or the maximum score for solving said problem.

In embodiments, the system includes a knowledge state monitoring and matching module, adapted to continuously monitor the knowledge state and compare it with a predetermined knowledge state goal for passing an final exam, wherein if the monitored knowledge state matches the predetermined knowledge state, the knowledge state monitoring and matching module is configured to provide as an output an instruction that the student has passed the exam.

In embodiments, the system includes the knowledge state monitoring and matching module is hidden for the student such that the student is not aware that he is being tested for passing the final exam during the interaction with the system.

In embodiments, the knowledge state module is adapted to predict, based on the history of the solutions input from the student, for each problem of the problems to be selected an expected score of the input solution at the present date, and optionally predict for each problem of the problems to be selected, an expected score of the input solution at a future date by taking into the history of the predicted expected score of the input solution at a respective present date, and wherein said predicted score at the present date or the predicted score at the future date is used by the problem selection module to select an appropriate problem.

In embodiments, the system includes a content filter module to block or not answer a question by determining that the student has asked a question which is not related to the specific course.

In embodiments, the similarity is not equal to or above the predetermined amount of similarity, the AI Bot module formulates an answer based on the data without using the pairs of artificial questions and related approved or rewritten answers, wherein the system in configured to mark the provided answer as not approved from the human person having knowledge in the field of the specific course and/or as having been generated by AI.

Other features and advantages of the present invention will become readily apparent from the following detailed description and the accompanying drawings.

### BRIEF DESCRIPTION OF THE DRAWINGS

The above and related objects, features and advantages of the present invention will be more fully understood by reference to the following, detailed description of the preferred, albeit illustrative, embodiment of the present invention when taken in conjunction with the accompanying figures, wherein:

FIG. 1 illustrates a schematic diagram of a system interacting with one or more human teachers via interface(s) and one or more students via visual interfaces to interactively train the one or more students in accordance with exemplary embodiments of the present invention;

FIG. 2 shows an example of the process performed bv the system shown in FIG. 1 in accordance with the exemplary embodiments of the present invention;

FIG. 3 illustrates an example dialogue in accordance exemplary embodiments of the present invention;

FIG. 4 illustrates a schematic diagram of a system configured to give qualitative and quantitative feedback to one or more students via visual interface(s) in accordance with exemplary embodiments of the present invention;

FIG. 5 shows an example of the process performed by system shown in FIG. 4 in accordance with exemplary embodiments of the present invention;

FIG. 6 illustrates an example of dialogue in accordance with exemplary embodiments of the present invention;

FIG. 7 illustrates a schematic diagram of system interacting with one or more human teachers via interface(s) and one or more students via visual interface(s) to interactively train the one or students in accordance with exemplary embodiments of the present invention; and

FIG. 8 illustrates an example of a dialogue in accordance with exemplary embodiments of the present invention.

### DETAILED DESCRIPTION

The present invention generally relates to improvements in computer technology related to systems and methods for adaptive remote learning.

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. In the following description, numerous details are set forth for the purpose of explanation. However, one of ordinary skill in the art will realize that the invention may be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

In order to provide greater clarity on the scope of the invention, the various embodiments of the present invention are described first before providing specific examples shown in the reference figures.

In embodiments, a student may use the help of an artificial knowledge bot (AI bot) in accordance with embodiments of the present invention. Such an artificial AI Bot (module) is an artificial intelligence module built on the so-called AI platform. In some embodiments, the bot may be in the form of a chatbot, which may converse with the user by way of a conversion by imitating humans and answer questions based on the support from a strong Al data platform in the background and propose various suggestions to users according to the conversation of the users.

For example, a specific AI Bot module is described in the granted patent EP 3,622,394 B1. As disclosed therein, a Bot module refers to an artificial intelligent (AI) module built on an AI data platform. In some cases, the Bot may be in a form of Chatbot, which may talk with user in a way of conversation by imitating humans, answer questions from users based on the support from a strong AI data platform on the background, and propose various suggestions to users according to conversation with users. The Bot module disclosed therein may access an AI data platform to obtain proposing cloud management suggestion after acquiring the profile and running status data of cloud resource. That is to say, the profile and running status data of cloud resource are input information of the Bot module, and the processing suggestion on cloud management is output information of Bot module. As disclosed therein, to acquire more professional cloud management suggestion, a third-party Bot module is used to generate cloud management suggestion.

Thus, the AI Bot module disclosed in said document may assess the AI data platform to obtain proposing cloud management suggestion after acquiring the profile and running the status data of cloud resource. That is to say, in embodiments of the present invention, the profile and running status data of cloud resources are input information for the bot module, and the processing suggestion on cloud management is the output information of the bot module. In embodiments, the system includes an intelligent cloud management system based on profiles.

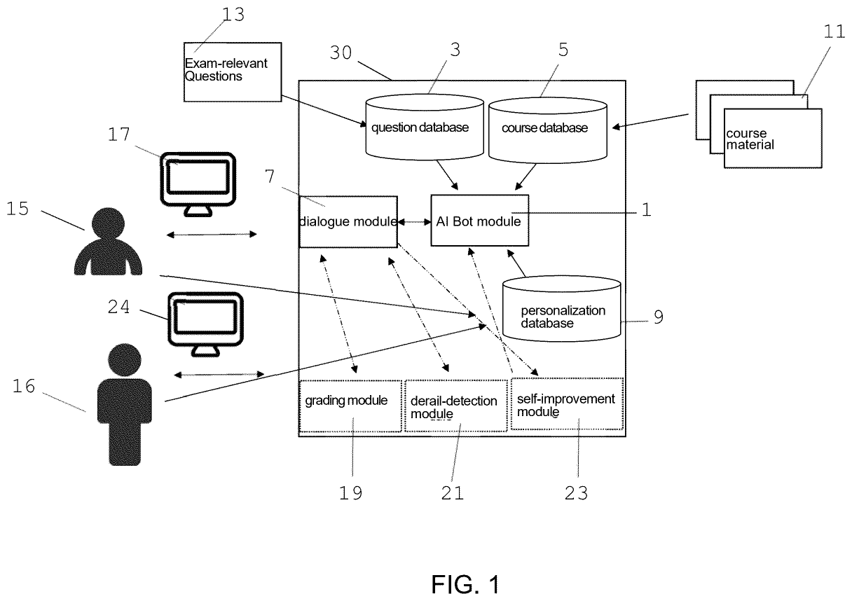

In embodiments, as discussed with respect to FIG. 1, the system comprises a course database, a question database, a dialogue module, an AI Bot module and a personalization database.

A module in this sense is a building block of a software system which represents a functionally closed unit and provides a specific service. However, in embodiments, any of the aforementioned modules may be combined to have some or all of the aforementioned modules combined in one higher level module. In embodiments, any of these modules may have further functionalities.

Generally, the dialogue module of the system is adapted to carry out an interactive dialogue with the student in order to be trained on the course material to be studied. In accordance with embodiments of the present invention, the dialogue module takes into account exam relevant questions and the course material to be studied.

In embodiments, with the help of the AI Bot module, a new question or answer to the previous answer or comment given by the student is set up. In embodiments, in order to set up this new question or answer, the Al Bot module takes into account the data of the course material and the data of the exam relevant questions.

Further and in accordance with embodiments of the present invention, this AI Bot module also takes into account personal attributes of the student which are contained in a personalization database. Thus, the personal attributes of the student are regarded such that the dialogue also deals with topics relevant to the attributes, but simultaneously covers the course material to be studied by the student and the exam relevant questions.

In embodiments, in the course database, data concerning course material to be studied by a student is stored. This course material may deal with a specific course. In embodiments, courses may be split up into so-called chunks, or into coursebooks, so the database may also have this data in a split-up fashion according to the chunks, which are small pieces of material to be studied by the students within one training session having e.g. a predetermined duration. In embodiments, the amount of material to be contained in the chunk is preset. In embodiments, the database contains at least one chunk or coursebook. For example, if the course deals with machine construction, there may be one course book about fluid dynamics which is to be studied by the student.

In embodiments, a question database is also be provided. This question database stores exam relevant questions. These exam relevant questions deal with the course material. An exam is usually passed if a predetermined percentage of the exam relevant questions are correctly answered by the student.

In embodiments, the dialogue in the dialogue module is conducted based on the course material and takes into regard the exam relevant questions.

In embodiments, based on a former answer or comment by the student, the AI Bot sets up a new question or answer in the dialogue. However, as explained above, it takes into account the personal attributes of the student.

An advantage of the present invention is that personal attributes of the student are regarded in the dialogue, thereby improving the learning effect of the student. As the material to be studied is matched to the personal preferences of the student, due to his practical experiences, the learning effect is superior to a learning when the personal attributes and/or experiences are not regarded.

In embodiments, these attributes may be one or more or all of the following: motivation for passing the course, professional background, personal interests, and admission documents.

Admission documents are documents required for the admission of the student to a specific course or study. Examples include one or more of the following: documents that provide evidence of the student's name, date of birth, any name changes, citizenship or residency; documents that provide evidence of what the student has studied; documents that provide evidence of the student's language proficiency in a required language; a portfolio or attendance at an interview or audition.

In embodiments, such attributes can be provided (e.g. to the university) by the student before starting the course and/or can be filled in a form via a respective software application visualized on a screen. These attributes may also be pre-set by supervisors or teachers into the system.

In embodiments, these attributes may also be updated during the course either by the student, or by the teachers or supervisors, or due to the answers and interests derived from the answers given by the students in this dialogue. In embodiments, the attributes of the student are taken into account in the dialogue.

In embodiments, the course material may consist of one coursebook having a specific topic or may consist of multiple coursebooks having different topics which are all related to a specific course or study. In embodiments, any coursebook may be split into smaller or bigger sections with a predetermined amount of content to be learned within one session (which may be named chunks). In embodiments, this course material is used in the course database to be matched with the exam relevant questions to set up the dialogue.

In embodiments, the Al Bot module is configured to adapt the complexity and/or content of the dialogue based on one or more or all of those attributes. In embodiments, one or more of those attributes are used as part of prompts to a machine learning model of the AI Bot module along with an instruction to take the attributes into account. For example, if a student's desired profession is “Product Manager in the EduTech industry”, a prompt may be modified to include, or generated to include, an instruction to adapt a provided example to be relevant to the target profession (e.g., “Product Manager in the EduTech Industry”.

In embodiments, additional to the aforementioned modules, or instead of the personalization database, a self-improvement module may be provided. The self-improvement module is configured to save dialogue data of the past dialogue (e.g., in a self-improvement database, not shown), which is then taken into account by the AI Bot module to set up a new question or answer in the dialogue. In embodiments, the self-improvement module replaces the personalization database. In this regard, in embodiments, the question or answer may be contained not only the course or question database. For example, a question or answer may be generated so as to lead to another question or answer in order to increase the efficacy of the training.

In embodiments, a derail detection module and a grading module, are additionally provided to the aforementioned modules or may replace one of the modules' personalization database, self-improvement module or the like.

In embodiments, the derail detection module detects whether the student asks a question or gives a comment which is not related to a specific course. In embodiments, if this is the case, the system is configured to steer the dialogue back to a specific course. For example, if derailing is detected, the system may start with a new question related to the course.

Additionally or alternatively, in embodiments, a so-called grading module may be further provided. This grading module may provide feedback concerning the knowledge status demonstrated in the dialogue history and how it compares to the knowledge required to pass the exam, e.g. in case a question on similar topic appears there. The result of such contrasting may be saved in the self-improvement module. Then the Al Bot module assesses whether the overall knowledge status of the student is such that they can pass the exam, wherein the AI Bot module takes the exam relevant questions saved in the question database into account for said assessment.

In accordance exemplary embodiments of the present invention, a method for interactively training students is additionally provided. In embodiments, the method includes the same features with which the aforementioned system works. In accordance with the method, the system carries out an interactive dialogue with the student on the course materials to be studied for a specific course, taking into account relevant exam questions. In embodiments, in this method, the answer or comment given by the student in the dialogue is used to set up a new question or answer in the dialogue to be answered or commented on, based on the data of the course material to be studied and the data of the exam relevant questions in order to set up the new question or answer. In embodiments, the aforementioned AI Bot module may be used, which takes the data of the course material to be studied and the data of the exam relevant questions into account.

Also in this method, in embodiments, the attributes of the student are regarded by the AI Bot such that the interactive dialogue also deals with topics which are relevant to the attributes, covers the course material to be studied by the student, and takes the exam relevant questions into account.

In embodiments, a computer readable medium containing instructions for carrying out the methods of embodiments of the present invention is also provided.

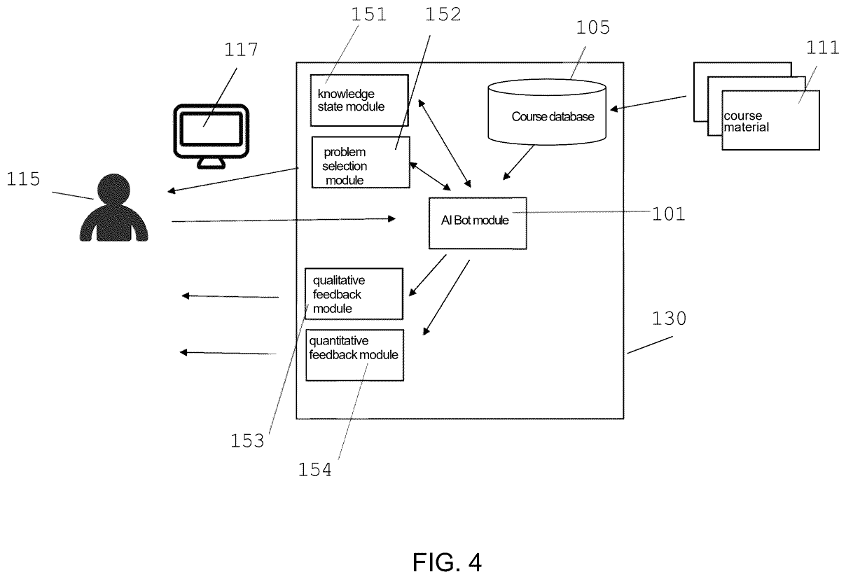

In exemplary embodiments of the present invention, a system for training students is provided, as shown for example in FIG. 4. This system present inventions in particular gives both quantitative feedback to the students in relation to their input solution of the problem and qualitative feedback in relation to their input solution to the problem.

In embodiments, a technique is used such that the problems which are generated by an AI Bot module on the course material to be studied are afterwards (after the generation) selected before the problem is given to the student to be answered, so that problems below a preset quality are removed from the list of possible problems to be solved. In embodiments, such a selection may be done automatically, e.g. in the below described problem selection module. In embodiments, AI Bot module is used to select possible problems to be solved.

In embodiments, in addition to, or instead of, the AI Bot module selecting possible problems to be solved, a problem selection module (or other suitable module) is used to select possible problems to be solved. In embodiments, the Al Bot module may be given an excerpt of the coursebook, a subset of existing exam problems, and a set of criteria of what makes a great exam question (e.g., based on factors such as level of difficulty, to give an example) as a prompt. Such module then evaluates if all the criteria for a great exam question are met, and if not, removes the question from the bank

In embodiments, instead of, or in addition to, such an automatic selection, the problem may be selected by a human person (e.g. teacher or supervisor).

As an advantage of this approach, partial interaction with a human person not only reduces the work of the teacher but also provides a certain one-to-one teaching because most of the training is done interactively with the student and the human person is only partially used to select problems below a threshold to ensure that a sufficient quality of the training has been provided. As another advantage, this feature of particularly selecting problems with the help of a human person helps to improve the quality of the training in addition to the advantages of, automatic selection.

In particular, in accordance with exemplary embodiments of the present invention, the system comprises a course database, an AI Bot module, a knowledge state module, a problem selection module, a quantitative feedback module, and a qualitative feedback module. The course database may be similar or identical to the aforementioned course database described with respect to the databases in FIG. 1. The course database comprises data of course material to be studied by a student for a specific course. This course material, as already described above, may be separated into a predetermined amounts, also known as chunks. In embodiments, based on this course material the AI Bot module sets up one or multiple problems (or questions) to be solved by the student. In an example, such a problem may be a description of the circumstances, and additionally circumstance-related questions are asked.

In embodiments, in order to train the students (e.g. before the exam), the system takes the knowledge state of the student into account in its selection of the problems because there are problems of different complexity and different levels of knowledge may be needed to solve the respective problem. Accordingly, in embodiments, a problem may be selected based on the probability of being solved by the student in view of the state of knowledge of the student

To illustrate, at the beginning of a study, for example, a student does not have so much knowledge and therefore the problems selected should not be too difficult to solve. However, during the training the problems selected should have a higher complexity and be more difficult to solve because the knowledge state of the student should increase during the training of the student with the system.

In embodiments, the state of the knowledge is determined with the so-called knowledge state module. In embodiments, the previously solved problem, and/or the duration of the study re provided as inputs to the knowledge state module. In embodiments, other information is provided as inputs to the knowledge state module, including, but not limited to, the current knowledge state and the student attributes to give a couple of examples. In embodiments, the knowledge state module takes into account (e.g., receives as an input) each problem solved (alongside with the attribution of the problem to a portion of the curriculum, and corresponding problem difficulty) each dialogue handled (e.g., a demonstrated level and comprehension achieved in dialogue). Based on these inputs, the knowledge state module generates estimates of what can be expected from the a student. For example, the knowledge state module may generate a conversative probability of a student's ability to pass an exam problem for a given part of the curriculum of a course a given difficulty level. In embodiments, the knowledge state module may rely on one or more rules. In embodiment, the knowledge state module may rely on one or more traits of the student.

In embodiments, to prevent some of the problems set up by the AI Bot module not having a prescribed quality to give the student a good learning experience, a preselection is done after the problems are generated by the AI Bot so that problems which are below a preset quality are removed from the possible problem list and thus only those problems which have a determined quality are given to the student to solve.

In embodiments, after the student inputs (e.g. via his voice and/or via his hand with e.g. a keyboard) the solution to the problem, quantitative as well as a qualitative feedback is given (e.g. output on a screen). This quantitative feedback may be given by the quantitative feedback module and the qualitative feedback may be given by the qualitative feedback module.

The quantitative feedback may be the general amount of points or a score this answer would be assigned in an exam. In embodiments, the quantitative feedback is the score given to the solution of the student and the Al Bot module is configured to take the selected problem to the question, solution input by the student, a reference answer, and the maximum score for solving said problem as inputs in order to generate the score In embodiments, the AI Bot module may use a large open-source transformer based model to generate a score based on the question, solution input by the student, the reference answer, and the maximum score. In embodiments, the AI Bot module is trained using sets of questions, answers, and corresponding grades. The corresponding grades may be manually assigned (e.g., by a human instructor, to give an example), and/or assigned by an artificial intelligence module (e.g., the Al Bot module after having been reviewed by a human instructor).

The qualitative feedback may state what was incorrect and what should have been submitted to receive full points or at least higher points. For example, the qualitative feedback may be a description explaining to the student what would have been needed to obtain a higher score or the maximum score for solving said problem.

In embodiments, the AI Bot module is configured to obtain as inputs the selected problem, the solution input by the student, and a reference answer.

In embodiments, a knowledge state monitoring and matching module integrated within the system are also provided.

In embodiments, the knowledge state monitoring and matching module is an expansion of the aforementioned knowledge state module. In embodiments, the knowledge state monitoring and matching module is adapted to continuously monitor the knowledge state of the student and compare it with a predetermined knowledge state goal for passing the final exam. If the monitored knowledge state matches the predetermined requirements for passing the exam, it is output as a message that the student has passed an exam, and/or the record may be saved in the student's transcript. Further it may be the case that this knowledge state monitoring and matching module is hidden from the student, and that the student is not aware that during their interaction with the system they are being continuously tested on whether they would pass the final exam. The module is hidden for the student such that the student is not noticing that he is being tested for passing the final exam during the interaction with the system-the experience appears to be just a continuous study on the subject. An advantage of such an embodiment is that it may increase the performance of student fearful of a final exam to pass because they would not know that during their question answering they were simultaneously undergoing an exam which they would pass when the quality of their answers reaches a predetermined threshold.

In embodiments, the knowledge state module may be adapted to predict (based on the history of the solutions input from the student for each problem out of the problems to be selected) an expected score of the input solution at a preset date. In embodiments, the knowledge state module may optionally predict (for each problem of the problems to be selected) an expected score of the input solution at a future date by taking into account the history of the input solution score at a respective present date, the score at the present date or the predicted score at the future date. The problem selection module then selects an appropriate problem. Better training goals and faster fulfillment of the requirements to pass an exam are obtained with this further improvement.

In embodiments, the following method for training students, named exam training, is provided. The method may be executed with the aforementioned system. In embodiments, data of the course material to be studied by the student is used and problems to be solved are set up by an AI Bot module. In embodiments, the actual knowledge state of the student is determined in accordance with embodiments of the present invention. A problem generated by an Al Bot dependent on the actual knowledge state of the student is selected, and after the student has input its solution, qualitative and quantitative feedback is given to the student.

In embodiments, before the problem is set up by the AI Bot module, the problems are selected by a human person having knowledge in the field of the specific course and problems which are below a present quality are removed from the possible problems to be selected.

In embodiments, a computer readable medium containing instructions for carrying out the aforementioned method is provided.

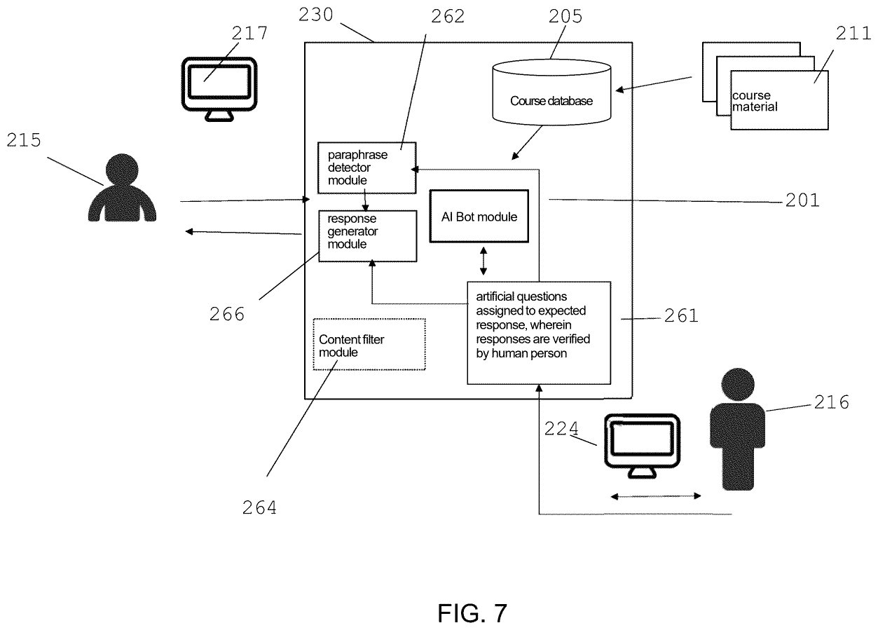

According exemplary embodiments of the present invention, a system for answering the questions of students is also provided, for example, as depicted in FIG. 7. This system comprises a course database, an Al Bot module, a paraphrase detector module, and a response generation module.

In embodiments, the system is configured to provide a respective answer to the student. The answer may be marked as an answer approved by a human person having knowledge in the field of the specific course material or may be marked as not approved by a human person having knowledge in the field of the specific course material and/or generated by the AI Bot module.

In embodiments, the AI Bot module uses the course material to be studied by the student to generate artificial questions which may be potentially asked by the students.

In embodiments, in order to do so, the AI Bot module obtains as an input content of the course material and creates a data set where a respective artificial question is assigned to an expected response set up from the content of the course material. Said response may also be generated by the AI Bot module. In embodiments, the AI Bot module may revise and/or elaborate on the answers/responses stored in the data set. In embodiments, the answers or responses may by elaborated and/or validated by the human person

In embodiments, the answers to the questions in the data set are reviewed and/or validated by a human person having knowledge in the field of the specific course.

In embodiments, answers are approved or rewritten by a human person, so that the dataset comprises pairs of artificial questions and related approved or rewritten answers. Said approved or rewritten answers are defined in the following as approved answers, because when an answer is rewritten it is inherently approved by the human person.

In embodiments, the artificial questions set up by the AI Bot module thus may at least be screened by a human person concerning quality and relevancy for the course or the passing of the course. This provides the advantage that the available artificial questions fulfill a certain quality and only those approved questions are taken into account for the further process.

In embodiments, AI Bot module is the same as the one described with respect to FIGS. 1 and 4. In embodiments, the AI Bot module is a different module than the one described with respect to FIGS. 1 and 4.

In embodiments, an input question is obtained by the AI Bot module from a student. In embodiments, based on the input question, the AI Bot module determines the similarity of the input question and an artificial question generated by the AI Bot module. If the similarity is within a predetermined threshold, or is equal to or above a predetermined amount of similarity between the input question and an artificial question set up by the AI Bot module, an answer is given to the student (e.g., caused to be displayed on a screen). In embodiments, the answer is generated in a response generation module. As the response, there is used this approved or rewritten answer of the pairs of artificial questions and related approved or rewritten answers, which corresponding artificial question has the highest or at least a predetermined similarity. In embodiments, the data set is searched for the artificial question which has the highest, or at least a predetermined, similarity to the input question from the student. The answer in the dataset which corresponds to said artificial question which has the highest, or at least a predetermined, similarity is given as answer. In embodiments, the AI Bot module may use a neural search engine, trained (e.g., by calibrating a sensitivity threshold) on a dataset of real student questions which are manually labelled (or ‘tagged’) as to whether they are similar to each other or not. In embodiments, the paraphrase detector module determines whether the question input from the student has a predetermined amount of similarity to the artificial question. If so, an appropriate response is given to the student based on the artificial question.

In embodiments, the system is configured to mark the provided answer as approved from the human person having knowledge in the field of the specific course, in particular by a visual tag. In this case the (e.g. visual or audible) information that the answer has not been approved by a human person and is AI generated.

In embodiments, a content filter module is also provided. This content filter module is configured to determine whether a question asked by the student is not related to a specific course, and if this is the case, then the question is either simply not answered or the student is informed that this is question blocked.

In embodiments, if the similarity is within a predetermined threshold, or is equal to or above a predetermined amount of similarity, the Al Bot module takes the course material into account and formulates an answer and in particular does not use the pairs of artificial questions and related approved or rewritten answers. The system may be configured to mark the provided answer as not approved from the human person having knowledge in the field of the specific course and/or as had been generated by AI. In embodiments, the AI Bot module may be configured to provide the answer in an output depending on the conversation with the student using an LLM (e.g., GPT-4, to give an example). In embodiments, the input to the LLM may include large excerpts of the coursebook. An advantage to such an approach is that it grounds the model and reduces hallucinations. In this case, the (e.g. visual or audible) information that the answer has not been approved by a human person and is AI generated. In embodiments, such a response may be routed to a human person for verification, and later the student could be given either a corrected answer or the information (e.g. visual or audible) information that the answer has now been approved by a human person.

Thus, in embodiments, information may be further provided to the student that this question has been answered by a human person and not by the AI Bot module. This information may be visualized on the screen on which the training is done.

In embodiments, for each question set up by the student not having a predetermined amount of similarity to an artificial question, an answer is formulated by a human person and said pairs of answer and question are added to the aforementioned data set. So the data set of questions and related answers grows during the use of the system. This added question with a corresponding approved answer is then later used in the assessment of whether or not there is similarity between an artificial question and a new question input by the student.

In exemplary embodiments, a method for answering questions is provided.

In embodiments, the method is executed by the aforementioned system.

In embodiments, an Al Bot module is set up with artificial questions which may be potentially asked by the student. In embodiments, the content of the course material is taken into account when setting up these artificial questions.

In embodiments, a data set is then created where a respective artificial question is assigned to an expected response set up by the Al Bot module from the content of the course material. In embodiments, the answers to the questions in the data set are reviewed by a human person having knowledge in the field of the specific course and approved or rewritten. As a consequence, the dataset comprises pairs of artificial questions and related approved or rewritten answers.

In this method an input question is then analyzed from the student for whether or not it has a the similarity within a predetermined threshold, or is equal to or above a predetermined amount of similarity.

In embodiments, if the similarity is within a predetermined threshold, or is equal to or above a predetermined amount of similarity, a response to the question is given, wherein this approved or rewritten answer of the pairs of artificial questions and related approved or rewritten answers are used as a response, which corresponds to the artificial question which has the highest or at least a predetermined similarity.

In exemplary embodiments, a computer readable medium containing instructions for carrying out the aforementioned method is provided.

In embodiments, the aforementioned systems may be provided as a software solution or computer program product. In embodiments, the software solution and computer program product may be run on a computer, personal digital assistant (“PDA”), cell phone, or other device accessible by the student. In embodiments, the software solution and computer program product may alternatively or also be configured to fully or partially run on a cloud or a server of the university or school and the student may have access via an application which may be installed on their device (e.g., a personal computer, a notebook, or a mobile device such as a PDA, to name a few examples).

In embodiments, the student device includes an input interface where the student can fill in the respective answers (e.g., a virtual interface with a touch screen or a physical keyboard, to name a few examples). In embodiments, additionally, or alternatively, a respective system may be provided where the interaction of the student with the application in accordance with embodiments of the present invention, is implemented by sound and instructions heard by the student, and in this case there must also be a speech recognition program present which recognizes the speech of the student and transfers it to the system as a written answer.

In embodiments, the systems, methods and program products can also be combined. In embodiments, for any system the same Al Bot module can be used. In embodiments, any of the aforementioned modules can be combined with any other of the modules in the aforementioned system.

Further details of the invention are described in the following in regard to the figures.

In the following several general setups of specific systems are described. However, in embodiments, any of the three below mentioned system examples may also be combined. Also (as long it makes technical sense) any of the modules in one system can be combined with a module in the other system, and any of three systems can be combined to define a new system that includes parts of only two of the systems.

In embodiments, the system is set up on a cloud or a server at the host (such as the university) and interaction with a student or other user is carried out via an application installed on the personal PC, a mobile device or any other device such as a PDA or smartphone of the student who studies the respective study. Even a smart home assistant can be an example of such a device. In embodiments, the study can be done, for example, remotely from a university location via the worldwide web.

In embodiments, the interaction of the student is either be done via a visual interface or via an audio interface where speech recognition is used to process the answers. Such an interface may also be a so-called multi modal interface, and may use as input and or output one or more of the following singularly or in combination: audio, video, images, to give a few examples.

In embodiments, the respective system is set up on one PC. In embodiments, the respective systems is set up on multiple PCs as a net of PCs with an artificial AI Bot module. This setup is generally known, and any of the respective software configurations that set up the aforementioned module can be implemented by the skilled artisan with his technical knowledge.

FIG. 1 shows a schematic diagram of system 30 interacting with one or more human teachers 16 via interface(s) 24 and one or more students 15 via visual interface(s) 17 to interactively train the one or students 15 in accordance with exemplary embodiments of the present invention.

As illustrated in FIG. 1, system 30 may include a plurality of modules, including an AI Bot module 1 operatively connected to a dialogue module 7, a grading module 19, a derail-detection module 21, and a self-improvement module 23. System 30 may also include a plurality of databases accessed and utilized by one or more of the plurality of modules, including, for example, question database 3, course database 5, and personalization database 9. The question database 3 may include, by way of illustration, exam-relevant questions 13. Course database 5 may include, by way of illustration, course material 11. Consistent with embodiments of the invention, one or more of the modules may be omitted and/or replaced with other modules. Consistent with embodiments of the invention, the databases may also contain other information.

The AI Bot module 1 takes into account course material data, which is stored in the course database 5, and data concerning exam relevant questions 13, which is stored in a question database 3. Exam relevant questions are questions with a relation to the course material, which is identified by reference sign 11. The course material 11 may be set up as small digestible chunks with a predetermined amount, which can be learned by the student in one session. This course material 11 may also be set up by different coursebooks.

Additional to the data in the question database 3 and the course database 5 the AI Bot module 1 uses the data in a personalization database 9. The personalization database 9 saves personal attributes of the students. The personal attributes may be motivation for passing the course, professional background, personal interest, or the present job of the student.

These three types of data (3, 5, and 9), are taken into account by (e.g., obtained by and used as inputs to) the AI Bot module 1, which sets up a new question or answer in accordance with embodiments of the present invention, and transfers it to the dialogue module 7, which then outputs it to the student 15.

The student 15 carries out an interactive dialogue with the dialogue module 7. A comment or answer given by the student 15 is fed to the dialogue module 7. Based on this answer or comment and the aforementioned three data inputs (e.g., from question database 3, course database 5, and personalization database 9), the new question is given to the student 15.

In embodiments, in addition to the question database 3, the course database 5, the dialogue module 7 and the personalization database 9, the system may comprise (as shown by the dotted boxes in FIG. 1) a grading module 19, a derail detection module 21, and a self-improvement module 23.

In embodiments, the grading module 19 is a module which gives feedback concerning the knowledge status of the student and may assess whether the student is able to pass an exam in accordance with embodiments of the present invention. In embodiments, the grading module may either give the feedback via the dialogue module 7 to the student as identified by an arrow in FIG. 1 or may directly give the information to the student.

This interaction of the student 15 with the system is schematically shown as being done via a visual interface 17, which is, in the present case, a screen, monitor, or other display on a PC. In accordance with embodiments of the present invention, the student 15 can input the data into the system via a keyboard or also via speech recognition. In embodiments, instead of the visual interface, a sound interface may be provided so that the dialogue module talks with the student.

In embodiments, the system includes a derail detection module 21 which detects whether the student asks a question or gives a comment in the dialogue, which is not related to a specific course in accordance with embodiments of the present invention. If this is the case, the dialogue is steered back to the specific course in accordance with embodiments of the present invention. Therefore, the derail detection module 21 may instruct the dialogue module 7 to direct the dialogue back to the specific topic.

In embodiments, the self-improvement module 23 may save the dialogue data of past dialogues, and the AI Bot module 1 may take this past dialogue data into account for setting up this new question.

Identified by reference sign 16 is a human person that isn't the student, for example it is a tutor, teacher or supervisor.

In embodiments, said teacher 16 may also fill in as shown by the arrow in FIG. 1 in the personalization data in the personalization database 9. In embodiments, the personalization database may be fed with data by the student 15 or by the teacher 16. In the embodiments, the personalization database 9 may be updated periodically when the respective attributes of the student 15 change.

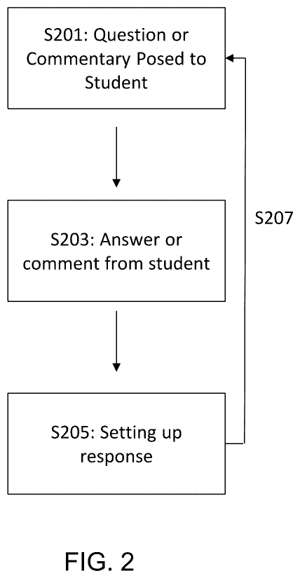

FIG. 2 shows an example of the process performed by system 30 shown in FIG. 1 in accordance with exemplary embodiments of the present invention. At step S201, a question or commentary is posed to a student, for example, using the dialogue module 7 via visual interface 17 (e.g., system question 301). In response to the question, student 15 remotely provides an answer (e.g., student answer 303) via visual interface 17, which is thereafter, in step S203, provided to dialogue module 7. Dialogue module 7, which is operated connected to Al Bot module 1 shares the answer to AI Bot module 1. Al Bot module 1 analyzes the answer in accordance with the chat history with student 15, the question database, the course database, and the personalization database to determine at step S205, a response, such as a new question or answer (e.g., system response 305) to be remotely presented to student 15 via the visual interface 17 and dialogue module 7. In embodiments, the response may include quantitative and/or qualitative feedback.

At step S207, this procedure may be reiterated and response generated in step S205 may provided to student 15 via visual interface.

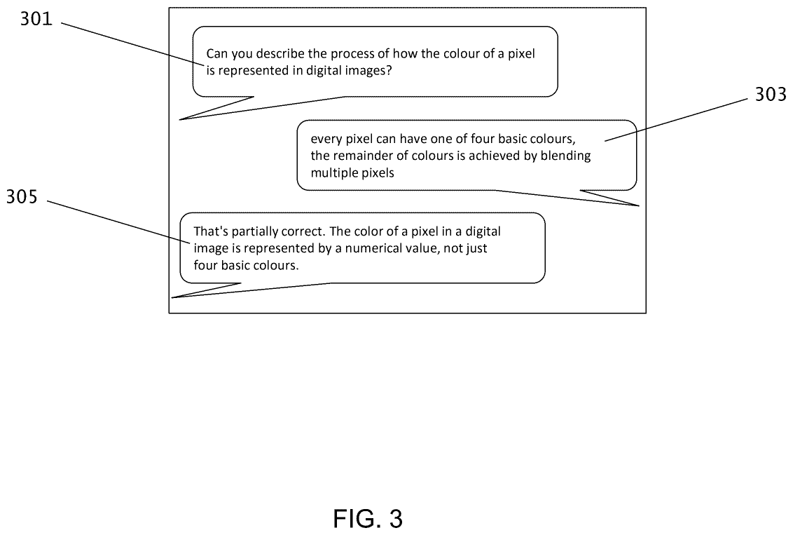

FIG. 3 illustrates an example dialogue in accordance with the exemplary embodiments of the present invention. There is given a question from the system to the student: “Can you describe the process of how the colors of a pixel is represented in a digital image?” (301). The student's answer is: “every pixel can have one of four basic colours, the remainder of colours is achieved by blending multiple pixels” (302). The response of the system is: “That's partially correct. The color of a pixel in a digital image is represented by a numerical value, not just four basic colours.” (305).

FIG. 4 illustrates a schematic diagram of system 130 configured to give qualitative and quantitative feedback to one or more students 115 via visual interface(s) 127 in accordance with exemplary embodiments of the present invention.

As illustrated in FIG. 4, system 130 may include a plurality of modules, including an AI Bot module 1 operatively connected to a knowledge state module 15, a problem selection module 152, a qualitative feedback module 153, and a quantitative feedback module 154. The system 130 may include other modules connected to the Al Bot module 101, including, for example, a dialogue module (not shown). System 130 may also include one or more databases accessed and utilized by one or more of the plurality of modules, including, for example, course database 105. Course database 105 may include, by way of illustration, course material 111. Consistent with embodiments of the invention, one or more of the modules may be omitted and/or replaced with other modules. Consistent with embodiments of the invention, the one or more databases may also contain other information.

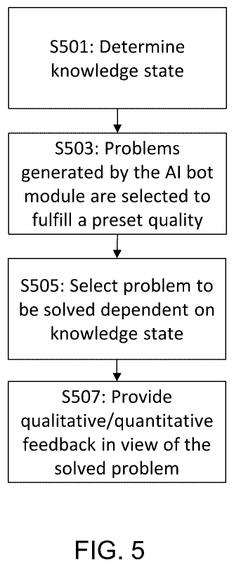

FIG. 5 shows an example of the process performed by system 130 shown in FIG. 4 in accordance with exemplary embodiments of the present invention. At step S501, the knowledge state module 151 determines a knowledge state for a student 115. At step S503, the AI Bot module 101 selects problems to be asked in order to fulfil a preset quality. Step S503 may be performed currently with, before, or after the knowledge state has been determined. Step S503 may also include generating, by the AI Bot module, problems to be solved before then determining whether they fulfil a preset quality. Based on the determined knowledge state, at step S505, the problem selection module 152 selects problems to be solved based on whether they fulfil a preset quality and the knowledge state of the student 115. Problems may be transmitted to the user using the dialogue module (not shown) similar to dialogue module 7 in FIG. 1 and the visual interface 117 (e.g., as an exam-like problem 601). A response may be obtained from the user, for example via visual interface 117 and the dialogue module (e.g., as the student's answer 603). Next, the response may be evaluated by the AI bot module 101, a quantitative feedback module 154 and a qualitative feedback module 153, before providing, at step S507, the qualitative and quantitative feedback to the student 115 in view of the solved problem (e.g., quantitative feedback 605 and qualitative feedback 609).

FIG. 5 illustrates an example dialogue in accordance with the exemplary embodiments of the present invention. A specific example of a problem (e.g., as generated in step S503 and selected at step S505), exam-like problem 601, given to the student: “What would be the output of the following code? How many lights would it print? . . . ”. The student provides an answer 603: “As the output, the code will print 49 lines”. The system provides quantitative feedback 605, scoring the student, a reference answer 607, which gives the correct answer, and qualitative feedback, 609, which provides additional qualitative information.

In embodiments, the generated problem may be of varying quality.

And in order to fulfill a good quality of this training, there is a step that from those problems which are generated by the Al Bot module, those are selected, which fulfill a preset quality.

In embodiments, this may be done by a human person e.g. a teacher (not shown in FIG. 4) having knowledge in the field of the specific course. In embodiments, in the system, a visual interface 117 may be provided to show the respective problems set up by the AI Bot module 101 to the human person. The human person selects the problems having a specific quality, and only those problems are used and provided to the problem selection module 152 to be provided for the student to solve.

In embodiments, such a selection may alternatively be done automatically as in the above described problem selection module 152 or by any other module in the system in accordance with embodiments of the present. This may also be done with the help of the AI Bot module in accordance with embodiments of the present invention.

However, for solving these problems, the knowledge state of the student 115 is also taken into account. This knowledge state is determined with the knowledge state module 151 (e.g., at step S501).

Thus, in embodiments, the present system also includes the knowledge state module 151 and the problem selection module 152. In embodiments, the problem is selected by the problem selection module 152 from the generated problems of the Al Bot module 101 (which are preselected by the human person to fulfill a respective quality) depending on the actual knowledge of the student 15.

In embodiments, if the knowledge of a student at the beginning of the course is not so high, or if the duration of the course is not so long, the problem to be solved by the student 15 will not have as high of a complexity as a problem to be solved by the student when they have higher knowledge and the problem is being posed shortly before the exam.

When the student 115 solves the problem, they further input the answer into the system (e.g., Student's Answer 603).

This may also be done via a graphical interface on the screen as seen in 117. This answer is used to provide qualitative and quantitative feedback to the student via the qualitative feedback module 153 and the quantitative feedback module 154 respectively.

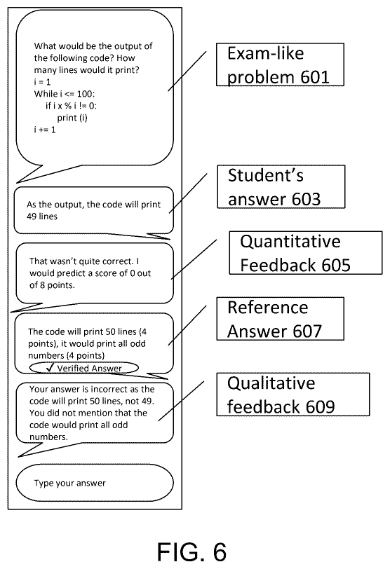

This is demonstrated in FIG. 6. FIG. 6 illustrates an example of dialogue in accordance with exemplary embodiments of the present invention. The answer 603 given by the student to the problem is, “as the output, the code will print 49 lines”.

And the referenced answer 607 is, “the code will print 50 lines”. Therefore, the quantitative feedback 605 returns, “I would predict a score of 0 out of 8”, and the qualitative feedback 609 returns, “Your answer is incorrect as the code prints 50 lines, not 49. You did not mention that the code will print all odd numbers”.

By the respective method, better learning performance and experience can be achieved.

In embodiments, a quantitative feedback may be given to the student; this feedback may be a score given to the solution of the student. In embodiments, the AI Bot module 101 is configured to calculate that score by taking the selected problems, the solution input by the student and its reference answer, and the maximum score for solving said problem into account.

Further, for qualitative feedback, the Al Bot module 101 may be configured to give the qualitative answer by taking the selected problems, the solution input to the student, and the reference answers into account, in accordance with embodiments of the present invention.

In embodiments, the knowledge state module 151 includes or is configured to use a knowledge state monitoring and matching module may be provided in the system. This is adapted to continuously monitor the knowledge state of the student in comparison with a predetermined knowledge state goal for passing the final exam. If the monitored knowledge state meets the predetermined knowledge state there may be output information that the student has passed the exam. This information may be output on the screen and/or the record may be saved in the student's transcript.

In embodiments, this knowledge state monitoring and matching module is be hidden from the student. An advantage of this technique is that the student does not know that they will take the exam during training. As a result, students which have fear ahead of the exam can be better trained and can have better results.

In embodiments, the knowledge state module 151 may predict an expected score, based on the history of the solutions input by the student, for each problem from the problems to be selected. It may also predict a score in the future by taking the history of the predicted expected score into account. When the predicted score at the present date or the predicted score at the future date is taken into account by the knowledge state module 151, an appropriate problem now or in the future can be selected.

FIG. 7 illustrates a schematic diagram of system 230 interacting with one or more human teachers 216 via interface(s) 224 and one or more students 215 via visual interface(s) 217 to interactively train the one or students 215 in accordance with exemplary embodiments of the present invention.

As illustrated in FIG. 7, system 230 may include a plurality of modules, including an AI Bot module 201 operatively connected to a paraphrase detector module 262, a response generator module 266, and a content filter module 264. System 130 may include other modules connected to the AI Bot module 201, including, for example, a dialogue module (not shown. System 30 may also include one or more databases accessed and utilized by one or more of the plurality of modules, including, for example, course database 205. Course database 205 may include, by way of illustration, course material 11. Consistent with embodiments of the invention, one or more of the modules may be omitted and/or replaced with other modules. Consistent with embodiments of the invention, the one or more databases may also contain other information.

In embodiments, Al Bot module 201 takes into account the data of course material 211, which is stored in the course database 205 in accordance with embodiments of the present invention.

First, the AI Bot module 201 sets up artificial questions and may assign them to expected responses shown at reference sign 261 in FIG. 7 (data set pairs of artificial questions and related approved or rewritten answers). This is done by taking the data of the course material into account. The expected responses may be generated by the Al bot module or by a human person e.g. a teacher.

In embodiments, the AI Bot module 201 takes into account the content of the course material and creates a data set where a respective artificial question is assigned to an expected response set up from the content of the course material.

In embodiments, at least the answers to the questions in the data set are reviewed by a human person 216 having knowledge in the field of the specific course.

Said answers are approved or rewritten by the human person 216, so that the dataset comprises pairs of artificial questions and related approved or rewritten answers.

The artificial questions set up by the Al Bot module 201 thus may at least be screened by a human person 216 concerning quality and relevancy for the course or the passing of the course. This provides the advantage that the available artificial questions fulfill a certain quality and only those approved questions are taken into account for the further process.

Thus, a so called “Gold Standard” list of questions and related answers is provided.

The paraphrase detector module 262 detects the question input from the student 215 and assesses if there is a predetermined amount of similarity to one of the artificial questions in accordance with embodiments with the present invention. If the similarity threshold is met there is given an answer contained in the “Gold Standard” list of questions and related answers. Thus, the input question from the student 215 undergoes a screening that if a predetermined amount of similarity between the input question and an artificial question set up by the AI Bot module 201 is achieved, an answer is given to the student (e.g. visualized on a screen).

In embodiments, said screening is executed in the response generation module 263. Said response generation module 263 generates, if there is predetermined amount of similarity in the input question, a response to the question. As a response this approved or rewritten answer is used, of the pairs of artificial questions and related approved or rewritten answers, which corresponding artificial question has the highest or at least a predetermined similarity.

In embodiments, that means the data set is searched for the artificial question which has the highest, or at least a predetermined, similarity to the input question from the student. The answer in the dataset which corresponds to said artificial question which has the highest or at least a predetermined similarity is given as answer.

In embodiments, the output answer is e.g. marked as an answer approved by a human person having knowledge in the field of the specific course material or as explained below may be marked as not approved by a human person having knowledge in the field of the specific course material and/or generated by the AI Bot module.

In embodiments, if the predetermined amount of similarity of the input question from the student 215 is not fulfilled, the AI Bot module takes the course material into account and formulates an answer. The thus provided answer is marked as not approved from the human person and/or is marked as had been generated by AI.

This marking may be made (by visual or audible) information. Such a response may be routed to a human person for verification, and later the student could be given either a corrected answer or information (e.g. visual or audible information) that the answer has now been approved by a human person.

In embodiments, for each question set up by the student not having a predetermined amount of similarity to an artificial question, an answer is formulated by a human person and said pairs of answer and question added to the aforementioned gold standard data set. So the data set of questions and related answers grows during the use of the system. In embodiments, this added question with corresponding approved answer is then later used in the assessment of whether or not there is similarity between an artificial question and a new question input from the student.

As an advantage, with this method it is not necessary to have a human person as teacher for every answer, so the number of teaching people can be reduced.

In embodiments, the student can interact with a visual interface 217.

In embodiments, a content filter module 264 is provided.

In embodiments, as this content filter module 264 is optional, it is shown by a dotted line in FIG. 7.

A content filter module 264 plays a role when the student asks a question that is not related to a specific course. If this is the case, the question is not answered, or the student is informed that the question is blocked.

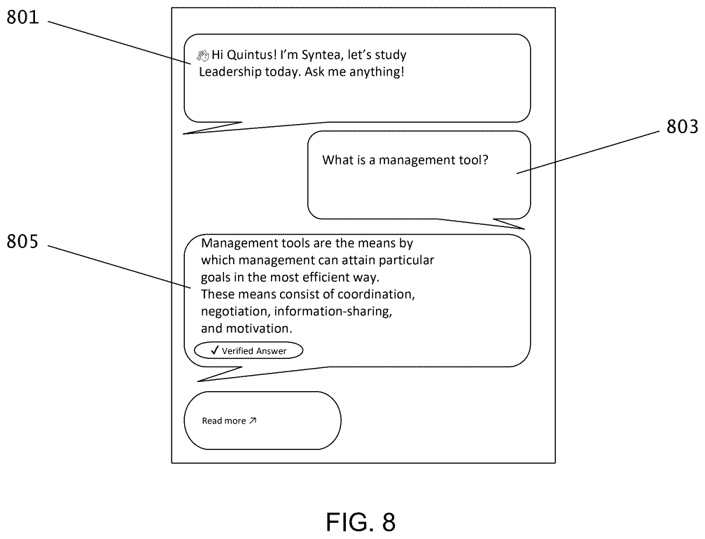

The general example on how the question answering may work is shown in FIGS. 2 and 8. FIG. 8 illustrates an example of a dialogue in accordance with exemplary embodiments of the present invention. In particular, FIG. 8 shows a general question and answer (system question 801, student response 803, and system response 805) wherein the student is further informed that the answer had before been verified by a tutor or teacher in accordance exemplary embodiments of the present invention.

In embodiments, as shown by FIG. 8, there is a sign which pops up in the answered question/system response 805, answered by one of the aforementioned systems, that this answer is verified by a human person (e.g. tutor or teacher or supervisor).

In embodiments, the aforementioned three different systems may also be combined within one system.

In embodiments, the respective modules for one of the three systems may be implemented in another system.

So for example, a self-improvement, derail detection or grading module for the first system may be implemented in any of the systems of the second and third system.

In exemplary embodiments a system for interactively training a student includes a course database including first data of a course material to be studied by the student for a specific course; a question database including second data of exam relevant questions related to the course material to be studied by the student, a predetermined percentage of which is required to be answered by the student to pass an exam related to the course; a dialogue module which is configured to carry out an interactive dialogue with the student about the course material to be studied by the student and regarding the exam relevant questions, wherein the interactive dialogue includes a first answer given in response to a first question; an AI Bot module which is configured to: obtain first data from the course database; obtain second data from the question database; and use the first answer given by the student in the dialogue to generate a new question or answer in the dialogue to be answered or commented by the student based on at least the first data and the second data; and a personalization database including personal attributes of the student, wherein the AI Bot module generates the interactive dialogue based on third data obtained from the personalization database, such that the interactive dialogue deals with topics which are relevant to the attributes and covers the course material to be studied by the student and takes the exam relevant questions into account.

In embodiments, the attributes of the student include motivation for passing the course, professional background, personal interests, and/or admission documents; and wherein in particular the AI Bot module is configured to adapt the complexity and/or content of the dialogue based on one or more or all of those attributes.

In embodiments, the course material includes at least one coursebook having a specific topic or multiple coursebooks having different topics which are related to the specific course of study.

In embodiments, the system further includes self-improvement module, in which the dialogue data of past dialogues is saved in a self-improvement database and the AI Bot module is configured to take the dialogue data into account to set up a new question or answer in the dialogue.

In embodiments, the system further includes a derail-detection module, in which it is determined that the student ask a question or gives a comment in the dialogue which is not related to the specific course, and if it is the case the dialogue is steered back to the specific course.

In embodiments, the system further includes a grading module, which is configured to give a feedback concerning the knowledge status to pass the exam based on the dialogue history.

In embodiments, a system for training a student includes a course database including data of a course material to be studied by the student for a specific course; an AI Bot module which is configured to use the data to set up multiple problems to be solved in an exam; a knowledge state module which is configured to determine the actual knowledge state the student; a problem selection module which is configured to select a problem generated by the AI bot dependent on the actual knowledge state the student; a quantitative feedback module configured to give a quantitative feedback to the student in relation to his input solution of the problem; a qualitative feedback module adapted to give a qualitative feedback to the student in relation to his input solution of the problem; wherein the system is configured to obtain a solution input from the student and provide quantitative feedback and qualitative feedback in response.,

In embodiments, the system is configured so that the problems are selected by a human person having knowledge in the file of the specific course.

In embodiments, the quantitative feedback is a score given to the solution of the student and the AI Bot module is configured to take the selected problem, the solution input by the student, a reference answer and the maximum score for solving said problem into account.

In embodiments, the qualitative feedback is a description explaining to the student what would have been needed to obtain a higher score or the maximum score for solving said problem.

In embodiments, the system includes a knowledge state monitoring and matching module, adapted to continuously monitor the knowledge state and compare it with a predetermined knowledge state goal for passing an final exam, wherein if the monitored knowledge state matches the predetermined knowledge state, the knowledge state monitoring and matching module is configured to provide as an output an instruction that the student has passed the exam.

In embodiments, the system includes the knowledge state monitoring and matching module is hidden for the student such that the student is not aware that he is being tested for passing the final exam during the interaction with the system.

In embodiments, the knowledge state module is adapted to predict, based on the history of the solutions input from the student, for each problem of the problems to be selected an expected score of the input solution at the present date, and optionally predict for each problem of the problems to be selected, an expected score of the input solution at a future date by taking into the history of the predicted expected score of the input solution at a respective present date, and wherein said predicted score at the present date or the predicted score at the future date is used by the problem selection module to select an appropriate problem.

In embodiments, a system for answering questions of students includes: a course database including data of a course material to be studied by the student for the specific course; an AI Bot module which is configured to: obtain the data; use the data to generate artificial questions which may be potentially based on content of the course material; use the data to generate a respective expected responses to each artificial question based upon the content of the course material; and create a data set where each artificial question is assigned to a respective expected response; wherein the answers to the questions in the data set are reviewed by a human person having knowledge in the field of the specific course and approved or rewritten, so that the dataset includes pairs of artificial questions and related approved or rewritten answers; a paraphrase detector module which is adapted to analyze a question input from the student whether it has a similarity equal to or above a predetermined amount of similarity to at least one of the artificial questions; and a response generation module which generates, if the similarity is equal to or above the predetermined amount of similarity to at least one of the artificial questions, a response to the question, wherein the is based on an approved or rewritten answer of the pairs of artificial questions and related approved or rewritten answers, which corresponding artificial question has the highest or at least a predetermined similarity, wherein the system in configured to provide the answer to the student.

In embodiments, the system in configured to mark the provided answer as approved from the human person having knowledge in the field of the specific course by a visual tag.

In embodiments, the system includes a content filter module to block or not answer a question by determining that the student has asked a question which is not related to the specific course.

In embodiments, the similarity is not equal to or above the predetermined amount of similarity, the AI Bot module formulates an answer based on the data without using the pairs of artificial questions and related approved or rewritten answers, wherein the system in configured to mark the provided answer as not approved from the human person having knowledge in the field of the specific course and/or as having been generated by Al.

Further embodiments of the invention are as follows:
1. A system for interactively training students comprising: a data module comprising data of a course material to be studied by the student for the specific course, a question module comprising data of exam relevant questions related to the course material to be studied by the student, a predetermined percentage of which is required to be answered by the student to pass an exam related to the course, a dialogue module which is adapted to carry out an interactive dialogue with the student about the course material to be studied by the student and regarding the exam relevant questions, an AI Bot module which is configured to use the answer or comment given by the student in the dialogue to set up a new question or answer in the dialogue to be answered or commented by the student based on the data of a course material to be studied by the student and the data of exam relevant questions, and a personalization module comprising personal attributes of the student, wherein the system is configured that the attributes of the student are regarded by the Al bot such that the interactive dialogue deals also with topics which are relevant to the attributes and covers the course material to be studied by the student and takes the exam relevant questions into account.
2. The system of item 1, wherein the attributes of the student are one or more of the group comprising the following: motivation for passing the course, professional background, personal interests, admission documents; wherein in particular the Al Bot module is configured to adapt the complexity and/or content of the dialogue based on one or more or all of those attributes.
3. The system of item 1 or 2, wherein the course material consist of one coursebook having a specific topic or comprises multiple coursebooks having different topics which are related to the specific course of study.
4. The system of any of the foregoing items 1 to 3 further comprising a self-improvement module, in which the dialogue data of passed dialogues is saved and the AI Bot module is configured to take the dialogue data into account to set up a new question or answer in the dialogue.
5. The system of any of the foregoing items 1 to 4 further comprising a derail-detection module, in which it is determined that the student ask a question or gives a comment in the dialogue which is not related to the specific course, and if it is the case the dialogue is steered back to the specific course.
6. The system of any of the foregoing items 1 to 5 further comprising a grading module, which is configured to give a feedback concerning the knowledge status to pass the exam based on the dialogue history.
7. Method of interactively training students comprising the steps of carrying out an interactive dialogue with the student about a course material to be studied by the student for a specific course and taking into account exam relevant questions, related to the course material to be studied by the student, a predetermined percentage of which is required to be answered by the student to pass an exam related to the course, wherein the answer or comment given by the student in the dialogue is used to set up a new question or answer in the dialogue to be answered or commented by the student based on the data of a course material to be studied by the student and the data of exam relevant questions, wherein in order to set up a new question or answer in the dialogue an Al Bot module is used which takes the data of a course material to be studied by the student and the data of exam relevant questions into account, wherein attributes of the student are regarded by the Al bot such that the interactive dialogue deals also with topics which are relevant to the attributes and covers the course material to be studied by the student and takes the exam relevant questions into account.
8. A computer readable medium containing instructions for carrying out the method defined in item 7.
9. A system for training students comprising: a data module comprising data of a course material to be studied by the student for the specific course, an Al Bot module which is configured to use the course material to be studied by the student to set up multiple problems to be solved in an exam, a knowledge state module which is adapted to determine the actual knowledge state the student, a problem selection module which is adapted to select a problem generated by the AI bot dependent on the actual knowledge state the student, a quantitative feedback module adapted to give a quantitative feedback to the student in relation to his input solution of the problem, a qualitative feedback module adapted to give a qualitative feedback to the student in relation to his input solution of the problem, wherein the system is configured that after the student has input the solution of the problem to the system the quantitative feedback and the qualitative feedback is given to the student, and wherein the system is further configured that before the problem which is set up by the Al Bot module is selected by the problem selection module, the problems are selected such that problems which are below a preset quality are removed from the possible problems to be selected.
10. The system of item 9, wherein the system is configured that the problems are selected by a human person having knowledge in the file of the specific course.
11. The system of item 9 or 10, wherein the quantitative feedback is a score given to the solution of the student and the AI Bot module is configured to take selected problem, the solution input by the student, a reference answer and the maximum score for solving said problem into account.
12. The system of any of item 9 to 12, wherein the qualitative feedback is an description explaining the student what would have be needed to obtain a higher score or the maximum score for solving said problem, the AI Bot module is configured to take selected problem, the solution input by the student, a reference answer into account.
13. The system of any of item 9 to 12, further comprising a knowledge state monitoring and matching module, which is adapted to continuously monitor the knowledge state and compares it with a predetermined knowledge state goal for passing an final exam, and if the monitored knowledge state matches the predetermined knowledge state, outputs an instruction that the student has passed the exam.
14. The system of item 13, wherein knowledge state monitoring and matching module is hidden for the student such that the student is not aware that he is tested for passing the final exam continuously during the interaction with the system.
15. The system of any of items 9 to 14, wherein the a knowledge state module which is adapted to predict based on the history of the solutions p input from the student for each problem of the problems to be selected an expected score of the input solution at the present date, and optionally predict for each problem of the problems to be selected an expected score of the input solution at a future date by taking into the history of the predicted expected score of the input solution at a respective present date, and wherein said predicted score at the present date or the predicted score at the future date is regarded by the problem selection module to select an appropriate problem.
16. A method for training students comprising the steps of Using data of a course material to be studied by the student to set up with an AI bot multiple problems to be solved in an exam, determining the actual knowledge state the student, selecting a problem generated by an AI bot dependent on the actual knowledge state the student, wherein after the student has input a solution of the problem the method further comprises to give a qualitative feedback and a quantitative feedback to the student, wherein before the problem which is set up by the AI Bot module is selected, the problems are selected by a human person having knowledge in the file of the specific course such that problems which are below a preset quality are removed from the possible problems to be selected.
17. A computer readable medium containing instructions for carrying out the method defined in item 16.
18. A system for answering questions of students comprising: a data module comprising data of a course material to be studied by the student for the specific course, an AI Bot module which is configured to use the course material to be studied by the student to set up artificial questions which may be potentially asked by the students taking into account the content of the course material and creating a data set where a respective artificial question is assigned to an expected response set up from the content of the course material, wherein the answers to the questions in the data set are reviewed by a human person having knowledge in the field of the specific course and approved or rewritten, so that the dataset comprises pairs of artificial questions and related approved or rewritten answers, a paraphrase detector module which is adapted to analyze a question input from the student whether it has a predetermined amount of similarity to at least one of the artificial question, and a response generation module which generates, if there is predetermined amount of similarity in the input question, a response to the question, wherein as response there is used this approved or rewritten answer of the pairs of artificial questions and related approved or rewritten answers, which corresponding artificial question has the highest or at least a predetermined similarity, wherein the system in configured to provide the answer to the student.
19. The system of item 18, wherein the system in configured to mark the provided answer as approved from the human person having knowledge in the field of the specific course, in particular by a visual tag.
20. The system of item 18 or 19, further comprising a content filter module with which it is determined that the student ask a question which is not related to the specific course, and if it is the case the question is not answered and/or the student is informed that the question is blocked.
21. The system of any of items 18 to 20 being configured that if there is not predetermined amount of similarity in the input question, the AI Bot module takes the course material into account and formulates an answer and in particular does not use the pairs of artificial questions and related approved or rewritten answers, wherein the system in configured to mark the provided answer as not approved from the human person having knowledge in the field of the specific course and/or as had been generated by AI.
22. A method for answering questions of students comprising the steps of Setting up with an AI Bot module artificial questions which may be potentially asked by the students taking into account the content of course material to be studied by the student for the specific course and creating a data set where a respective artificial question is assigned to an expected response set up by the AI Bot module from the content of the course material, wherein the answers to the questions in the data set are reviewed by a human person having knowledge in the field of the specific course and approved or rewritten, so that the dataset comprises pairs of artificial questions and related approved or rewritten answers, analyzing a question input from the student whether it has a predetermined amount of similarity to at least one of artificial question generating, if there is predetermined amount of similarity in the input question, a response to the question, wherein as response there is used this approved or rewritten answer of the pairs of artificial questions and related approved or rewritten answers, which corresponding artificial question has the highest or at least a predetermined similarity, and providing the answer to the student.
23. A computer readable medium containing instructions for carrying out the method defined in item 22.
In the aforementioned further embodiments, the data module may correspond to the described course database, the question module may correspond to the described question database, the personalization module may correspond to the described personalization database, the self-improvement module may correspond to the described self-improvement database. So each described database may also be defined as “module”. Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

### REFERENCE SIGN LIST

1, 101, 201 AI Bot module
3 question database

5, 105, 205 course database
7 dialogue module
9 personalization database
11, 111, 211 course material
13 data concerning exam and relevant questions
15, 115, 215 student
16 tutor, teacher
17, 117 visual interface
19 grading module
21 derail detection module
23 self-improvement module
151 knowledge state module
152 problem selection module
153 qualitative feedback module
154 quantitative feedback module
261 artificial questions assigned to expected responses
262 paraphrase detector module
263 response generation module
301, 801 system question
305, 805 system response
303, 603, 803 student answer/response
601 exam-like problem
605 quantitative feedback
607 reference answer
609 qualitative feedback

What is claimed is:

1. A system for interactively training a student comprising:
a course database comprising first data of a course material to be studied by the student for a specific course;
a question database comprising second data of exam relevant questions related to the course material to be studied by the student, a predetermined percentage of which is required to be answered by the student to pass an exam related to the course;
a dialogue module which is configured to carry out an interactive dialogue with the student about the course material to be studied by the student and regarding the exam relevant questions, wherein the interactive dialogue includes a first answer given in response to a first question;
an AI Bot module which is configured to:
obtain first data from the course database;
obtain second data from the question database; and
use the first answer given by the student in the dialogue to generate a new question or answer in the dialogue to be answered or commented by the student based on at least the first data and the second data; and
and a personalization database comprising personal attributes of the student, wherein the AI Bot module generates the interactive dialogue based on third data obtained from the personalization database, such that the interactive dialogue deals with topics which are relevant to the attributes and covers the course material to be studied by the student and takes the exam relevant questions into account.

2. The system of claim 1, wherein the attributes of the student include motivation for passing the course, professional background, personal interests, and/or admission documents; and wherein in particular the AI Bot module is configured to adapt the complexity and/or content of the dialogue based on one or more or all of those attributes.

3. The system of claim 2, wherein the course material comprises at least one coursebook having a specific topic or multiple coursebooks having different topics which are related to the specific course of study.

4. The system of claim 3 further comprising a self-improvement module, in which the dialogue data of past dialogues is saved in a self-improvement database and the AI Bot module is configured to take the dialogue data into account to set up a new question or answer in the dialogue.

5. The system of claim 4 further comprising a derail-detection module, in which it is determined that the student ask a question or gives a comment in the dialogue which is not related to the specific course, and if it is the case the dialogue is steered back to the specific course.

6. The system of any of claim 5 further comprising a grading module, which is configured to give a feedback concerning the knowledge status to pass the exam based on the dialogue history.

7. A system for training a student comprising:
a course database comprising data of a course material to be studied by the student for a specific course;
an AI Bot module which is configured to use the data to set up multiple problems to be solved in an exam;
a knowledge state module which is configured to determine the actual knowledge state the student;
a problem selection module which is configured to select a problem generated by the AI bot dependent on the actual knowledge state the student;
a quantitative feedback module configured to give a quantitative feedback to the student in relation to his input solution of the problem;
a qualitative feedback module adapted to give a qualitative feedback to the student in relation to his input solution of the problem;
wherein the system is configured to obtain a solution input from the student and provide quantitative feedback and qualitative feedback in response.

8. The system of claim 7, wherein the system is configured so that the problems are selected by a human person having knowledge in the file of the specific course.

9. The system of claim 8, wherein the quantitative feedback is a score given to the solution of the student and the AI Bot module is configured to take the selected problem, the solution input by the student, a reference answer and the maximum score for solving said problem into account.

10. The system of claim 9, wherein the qualitative feedback is a description explaining to the student what would have been needed to obtain a higher score or the maximum score for solving said problem.

11. The system of claim 10, further comprising a knowledge state monitoring and matching module, adapted to continuously monitor the knowledge state and compare it with a predetermined knowledge state goal for passing an final exam, wherein if the monitored knowledge state matches the predetermined knowledge state, the knowledge state monitoring and matching module is configured to provide as an output an instruction that the student has passed the exam.

12. The system of claim 11, wherein the knowledge state monitoring and matching module is hidden for the student such that the student is not aware that he is being tested for passing the final exam during the interaction with the system.

13. The system of claim 12, wherein the knowledge state module is adapted to predict, based on the history of the solutions input from the student, for each problem of the problems to be selected an expected score of the input solution at the present date, and optionally predict for each problem of the problems to be selected, an expected score of the input solution at a future date by taking into the history of the predicted expected score of the input solution at a respective present date, and wherein said predicted score at the present date or the predicted score at the future date is used by the problem selection module to select an appropriate problem.

14. A system for answering questions of students comprising:
a course database comprising data of a course material to be studied by the student for the specific course;
an AI Bot module which is configured to:
obtain the data;
use the data to generate artificial questions which may be potentially based on content of the course material;
use the data to generate a respective expected responses to each artificial question based upon the content of the course material; and
create a data set where each artificial question is assigned to a respective expected response;
wherein the answers to the questions in the data set are reviewed by a human person having knowledge in the field of the specific course and approved or rewritten, so that the dataset comprises pairs of artificial questions and related approved or rewritten answers;
a paraphrase detector module which is adapted to analyze a question input from the student whether it has a similarity equal to or above a predetermined amount of similarity to at least one of the artificial questions;
and a response generation module which generates, if the similarity is equal to or above the predetermined amount of similarity to at least one of the artificial questions, a response to the question, wherein the is based on an approved or rewritten answer of the pairs of artificial questions and related approved or rewritten answers, which corresponding artificial question has the highest or at least a predetermined similarity,
wherein the system in configured to provide the answer to the student.

15. The system of claim 14, wherein the system in configured to mark the provided answer as approved from the human person having knowledge in the field of the specific course by a visual tag.

16. The system of claim 15, further comprising a content filter module to block or not answer a question by determining that the student has asked a question which is not related to the specific course.

17. The system of any claim 16, wherein the similarity is not equal to or above the predetermined amount of similarity, the AI Bot module formulates an answer based on the data without using the pairs of artificial questions and related approved or rewritten answers, wherein the system in configured to mark the provided answer as not approved from the human person having knowledge in the field of the specific course and/or as having been generated by AI.
